(19) United States
(12) Patent Application Publication
(10) Pub. No.: US 2007/0280849 A1
(43) Pub. Date: Dec. 6, 2007

(54) Friction stir welding process and structure

(75) Inventors: Fumiaki Fukuchi, Saitama (JP); Mitsuru Sayama, Saitama (JP); Tetsuya Miyahara, Saitama (JP); Eiji Ishida, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/789,606

(22) Filed: Apr. 25, 2007

(30) Foreign Application Priority Data
May 8, 2006 (JP) 2006-129595

(51) Int. Cl. C22C 21/04; B23K 20/12

(52) U.S. Cl. 420/546; 228/114.5

(57) ABSTRACT

The present invention relates to a friction stir welding process for joining two members having different shearing strengths, and a friction stir welded structure fabricated by the process. The friction stir welding process includes the step of positioning a first welded member and a second welded member such that both members overlap each other, thereby defining an overlapped region, and the step of inserting a rotating pin into the overlapped region from a surface of the second welded member, so that the first and second welded members are joined together. In this process, the first welded member has a lower shearing strength than that of the second welded member.

### CROSS-REFERENCE TO RELATED APPLICATIONS

This application claims the benefit of Japanese Patent Application 2006-129595 filed on May 8, 2006, the disclosure of which is incorporated herein by reference.

### BACKGROUND OF THE INVENTION

1. Field of the Invention

The present invention relates to a friction stir welding process for joining two members having different shearing strengths, and a friction stir welded structure fabricated by the process.

2. Description of the Related Art

Friction stir welding (referred to as “FSW”) is an established technique for joining two members made of, for example, aluminum alloy. In an FSW process, firstly, two members are stacked partially, thereby defining an overlapped portion. Subsequently, a pin rotating at a high speed is made to approach the materials. Following this, the rotating pin reaches the overlapped portion. Finally, the pin is fed over the overlapped portion, so that two materials are joined together.

U.S. Pat. No. 6,051,325 discloses a technique related to an FSW process. In this process, two materials made of, for example, aluminum alloy are overlapped with each other, thereby forming an overlapped region. Then, a rotating pin is inserted into the overlapped region from a surface of one of the materials, whereby the materials are joined together.

In such an FSW process, the following incident naturally occurs. When a rotating pin is inserted into an overlapped region from a surface of one of two materials, the overlapped region is plasticized. In this state, the plasticized part of the material enters the plasticized part of the other member into which the rotating pin is inserted (see a portion denoted by a reference numeral 41d in FIG. 4B). This entered part is called an “overlaid portion.”

If the height of the overlaid portion (referred to as “overlaid height”) reaches a considerable level, then the material fails to have a sufficient thickness. This property may be responsible for one factor in decreasing the FSW strength.

Therefore, in order to increase the FSW strength, the overlaid height needs to be lowered. In other words, an amount by which the plasticized portion of one member goes into the plasticized portion of the other member needs to decrease. This ensures a sufficient thickness of the member into which the rotating pin has been inserted. Consequently, it is possible to increase the FSW strength.

The overlaid portions are created due to the difference between shearing strengths of both members. In conventional processes, members made of the same material, that is, members having the same shearing strength have been used. Therefore, it has been difficult to lower the overlaid height.

Taking the above disadvantage into account, the present invention has been conceived. An object of the present invention is to provide an FSW process for producing welded structures having high welding strength, and welded structures manufactured by this process.

### SUMMARY OF THE INVENTION

According to an aspect of the present invention, there is provided, a friction stir welding process including:

a1) positioning a first welded member and a second welded member such that both members overlap each other, thereby defining an overlapped region; and
a2) inserting a rotating pin into the overlapped region from a surface of the second welded member, so that the first and second welded members are joined together, wherein the first welded member has a lower shearing strength than that of the second welded member.

According to another aspect of the present invention, there is provided, a friction stir welded structure being formed by a process including:

b1) positioning a first welded member and a second welded member such that both members overlap each other, thereby defining an overlapped region; and
b2) inserting a rotating pin into the overlapped region from a surface of the second welded member, so that the first and second welded members are joined together, wherein the first welded member has a lower shearing strength than that of the second welded member.

With the present invention, it is possible to present the friction stir welding process for fabricating structures having a high welding strength, as well as structures having a high welding strength.

Other aspects, features and advantages of the present invention will become apparent upon reading the following specification and claims when taken in conjunction with the accompanying drawings.

### BRIEF DESCRIPTION OF THE DRAWINGS

For more complete understanding of the present invention and the advantages hereof, reference is now made to the following description taken in conjunction with the accompanying drawings wherein:

FIG. 1 is a schematic view depicting a welding tool used in a typical FSW process;

FIG. 2 is a schematic view depicting an FSW process according to an embodiment of the present invention;

FIG. 3 is a schematic view depicting an FSW machine, and materials to be subjected to the FSW process;

FIG. 4A is a photomicrograph showing a cross-section of a first welded structure according to the embodiment; and

FIG. 4B is a photomicrograph showing a cross-section of a second welded structure of a comparative example.

### DETAILED DESCRIPTION OF THE EXEMPLARY EMBODIMENTS OF THE INVENTION

A detailed description will be given below, of an FSW process according to an embodiment of the present invention, with reference to accompanying drawings.

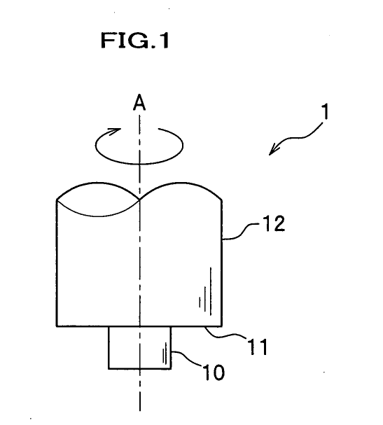

Referring to FIG. 1, a welding tool 1 is used in a typical FSW process, and it includes a cylindrical rotor 12, and a substantially cylindrical pin 10 sticking out from the bottom of the cylindrical rotor 12. The rotor 12 and the pin 10 are coaxial with each other. In addition, the rotor 12 has a larger diameter than that of the pin 10, and it forms a shoulder part 11 on the bottom from which the pin 10 protrudes.

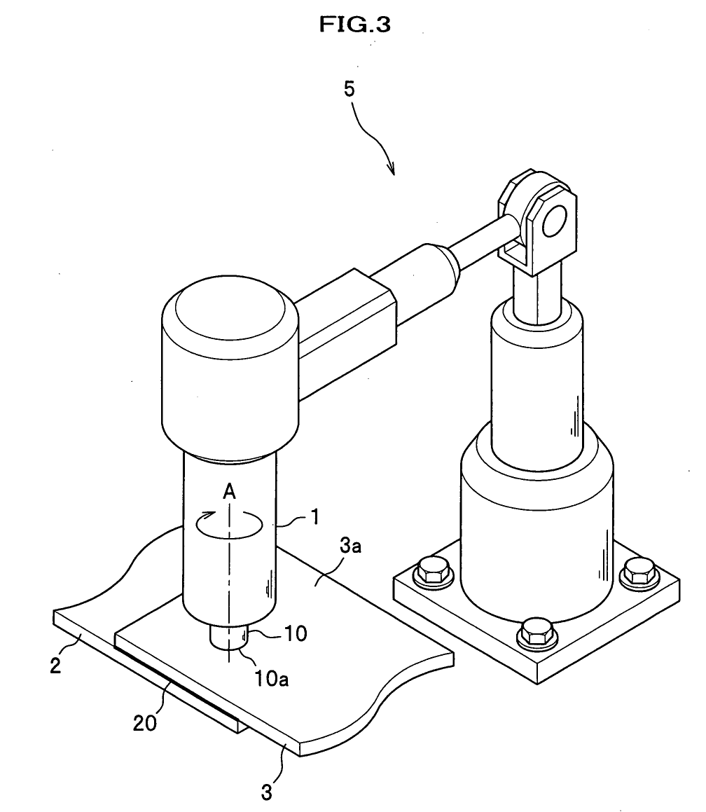

The welding tool 1 is configured to rotate about a rotational axis A at a high speed. Further, the pin 10 also rotates in conjunction with the welding tool 1. The rotation of the welding tool 1 is controlled by an FSW machine 5 implemented by, for example, a robot arm as shown in FIG. 3.

Preferably, the FSW machine 5 has a function of traveling the welding tool freely in the vertical direction with respect to the rotational axis A.

Thanks to this function, the FSW machine 5 can travel the welding tool 1 in parallel with a surface of a member while the welding tool 1 is rotating. Consequently, workpieces can be welded by a desired length.

Moreover, it is preferable that the FSW machine 5 possesses a function of traveling the welding tool 1 freely in the lateral direction with respect to the rotational axis A.

Owing to this function, the FSW machine 5 can insert the pin 10 into a member or removes therefrom.

The pin 10 may have a screwed form, although being not limited to any specific forms.

In this embodiment, the FSW machine 5 is implemented by the robot arm, but it is not limited to this implementation. Alternatively, the FSW machine 5 may be an NC working machine such as a milling machine.

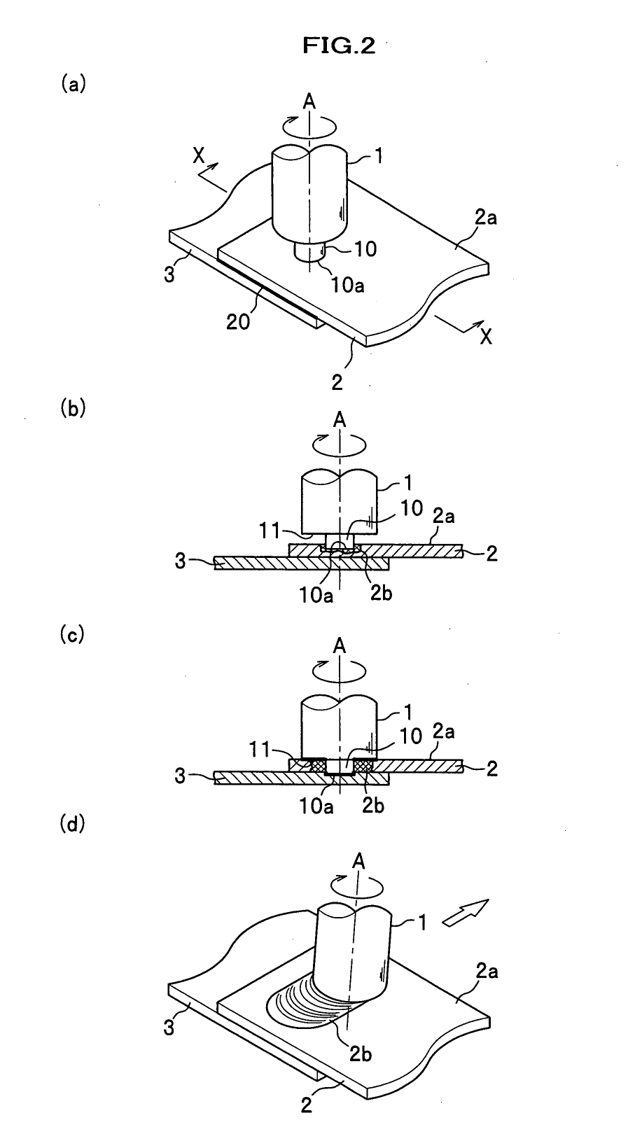

FIG. 2 shows an FSW process according to this embodiment. FIG. 2(a) shows two materials forming an overlapped region. FIG. 2(b) is a cross-section view taken along an X-X line of FIG. 2(a), and shows a plasticized region created by a rotating pin. FIG. 2(c) is a cross-section view taken along an X-X line of FIG. 2(a), and shows an arrangement where the shoulder part of the welding tool is in contact with a workpiece. FIG. 2(d) shows an arrangement where the welding tool is being fed laterally on the surface of the material. Note that the following description of the embodiment will be given on the assumption that the FSW machine 5 is implemented by a robot arm as shown in FIG. 3.

In this embodiment, two members to be welded have different shearing strengths. The member having a lower shearing strength (low-strength member) 3 is represented by a first welded member, while the member having a higher shearing strength (high-strength member) 2 is represented by a second welded member.

As shown in FIG. 2(a), the high-strength member 2 and the low-strength member 3 are overlapped to thereby define an overlapped region 20. In this case, the two members are arranged such that the pin 10 can be inserted into the high-strength member 2, that is, such that the high-strength member 2 positioned over the low-strength member 3 as shown in FIG. 2(a).

After forming the overlapped region 20 as in FIG. 2(a), the members 2 and 3 are secured with respect to the FSW machine 5 by a clamping tool (not shown) such that the overlapped region 20 is located perpendicular to the rotational axis A of the welding tool 1.

The FSW machine 5 allows the rotating welding tool 1 to approach a surface 2a of the high-strength member 2. Following this, a tip 10a of the pin 10 which rotates at a high speed in conjunction with the welding tool 1 is brought into contact with an initial welding point on the surface 2a of the high-strength member 2.

The tip 10a of the pin 10 is still rotating on the initial welding point. As a result, frictional heat is generated between the tip 10a and the surface 2a.

Because of this frictional heat, a temperature of the high-strength member 2 rises. Consequently, the high-strength member 2 softens without reaching its melting point, thus creating a plasticized region 2b as shown in FIG. 2(b).

The FSW machine 5 presses the welding tool 1 against the surface 2a of the high-strength member 2 at a predetermined power, while rotating the tool 1 at a high speed. Eventually, the tip 10a of the pin 10 goes into the plasticized region 2b, while pressurizing the surface 2a of the high-strength member 2. Following this, the shoulder portion 11 is brought into contact with the surface 2a of the high-strength member 2, as shown in FIG. 2(c).

The shoulder portion 11 which rotates at a high speed presses the surface 2a of the high-strength member 2. Subsequently, the rotating shoulder portion 11 traverses the surface 2a of the high-strength member 2 in parallel with the surface 2a, as shown in FIG. 2(d).

The FSW machine 5 feeds the rotating welding tool 1 by a desired distance, and then, it allows the welding tool 1 to come off the surface 2a of the high-strength member 2. When the pin 10 comes off the plasticized region 2b, the FSW process is over.

In this embodiment, the FSW process is performed by the step of moving the welding tool 1 of the FSW machine 5 in parallel with the surface 2a of the high-strength member 2 while the welding tool 1 is rotating at a high speed. However, the present invention is not limited to this step. Alternatively, the welding tool 1 may not move in parallel with the surface 2a of the high-strength member 2. In this case, a spot FSW is carried out.

### EXAMPLE

In order to explain the effect of the present invention, the following concrete examples will be presented.

In this example, Al-3Mg (Al—Mg alloy) is used as the high-strength member 2, and Al-8Si-0.3Mg (Al—Si alloy) is used as the low-strength member 3.

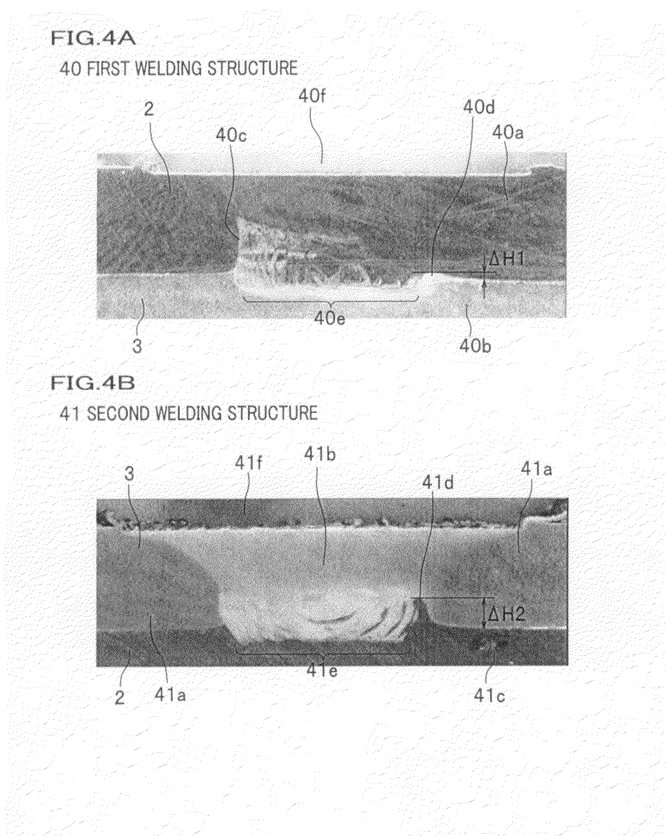

Now, a first welded structure 40 according to the embodiment of the present invention is fabricated (see FIG. 4A). During this fabricating process, firstly, the high-strength member 2 and the low-strength member 3 are stacked partially to create the overlapped region 20 such that the high-strength member 2 faces the pin 10, as shown in FIG. 2(a). Subsequently, the rotating pin 10 is inserted into the surface 2a of the high-strength member 2. As a result, an FSW structure is fabricated.

Next, a second welded structure 41 (see FIG. 4B) is fabricated as a comparative example. The overlaid height and welding strength of this structure are compared to those of the first welded structure 40. The second welded structure 41 is manufactured as follows. The high-strength member 2 and the low-strength member 3 are stacked such that the low-strength member 3 faces the pin 10, thereby forming an overlapped region 20. Next, the rotating pin 10 is inserted into a surface 3a of the low-strength member 3, and the FSW process is performed.

The fabricating process of the second welded structure 41 is similar to that of the embodiment, except that the rotating pin 10 is inserted into the surface 3a of the low-strength member 3.

A table 1 shows configurations of the first and second welded structures 40 and 41, and process condition of the FSW.

TABLE 1

| | | SECOND |
|---|---|---|
| | FIRST STRUCTURE | STRUCTURE |
| MEMBER | MATERIAL: | MATERIAL: |
| INTO WHICH | AL-3 Mg | AL-8Si-0.3 Mg |
| PIN IS INSERTED | (HIGH-STRENGTH) | (LOW-STRENGTH) |
| | THICKNESS: 3.0 mm | THICKNESS: 3.0 mm |
| THE OTHER MEMBER | MATERIAL: | MATERIAL: |
| | AL-8Si-0.3 Mg | AL-3 Mg |
| | (LOW-STRENGTH) | (HIGH-STRENGTH) |
| | THICKNESS: 4.0 mm | THICKNESS: 4.0 mm |
| ROTATIONAL SPEED | 1250 rpm | 1250 rpm |
| OF TOOL | | |
| PRESS LOAD OF | 73.5 MPa | 73.5 MPa |
| TOOL | | |
| WELDING SPEED | 600 mm/rpm | 600 mm/rpm |

In the table 1, the “PRESS LOAD OF TOOL” means a load by which the welding tool 1 of the FSW machine 5 presses the high-strength member 2 or the low-strength member 3 (FIG. 2 or 3).

FIGS. 4A and 4B show a photomicrograph of the overlapped region in the first and second welded structures, respectively.

In FIG. 4A, a light gray layer 40b indicates the low-strength member 3, and a dark gray layer 40a indicates the high-strength member 2. Furthermore, an upper part 40c and a lower part 40e form a contact portion. The pin 10 (see FIG. 2(a)) was inserted from a pin insert surface 40f.

The overlaid height in the first welded structure 40 is denoted by ΔH1.

The height of the upper part 40c is not considered to be the overlaid height, because the upper part 40c is a combination of the high-strength and low-strength members 2 and 3. Accordingly, it is regarded as a part of the contact portion.

In FIG. 4B, a dark gray layer 41c represents the high-strength member 2, and both a gray region 41a and a light gray region 41b represent the low-strength member 3. The lower part 41e in the high-strength member 2 is a contact portion. Note that the pin 10 (see FIG. 3) was inserted from the pin insert surface 41f.

The height ΔH2 of upper part 41d of the high-strength member 2 represents the overlaid height of the second welded structure 41.

In order to evaluate the welding strengths of the first and second welded structure 40 and 41, a tensile test is conducted on them.

A table 2 shows overlaid heights ΔH1 and ΔH2 of the first and second welded structure 40 and 41, and results of the tensile test on them, respectively.

TABLE 2

| | FIRST STRUCTURE | SECOND STRUCTURE |
|---|---|---|
| OVERLAID HEIGHT | ΔH1: 0.08 mm | ΔH2: 0.87 mm |
| TENSILE | 125.5 MPa | 76.5 MPa |
| STRENGTH | | |

The table 2 proves that the first welded structure 40 has the lower overlaid height than that of the second welded structure 41. Also, it demonstrates that the first welded structure 40 can withstand a greater tensile strength than the second welded structure 41 does.

In the evaluation of the tensile strength, it is preferable that test samples are fabricated at the same FSW temperature. In this example, both structures are manufactured at a temperature of about 450° C.

As described above, the FSW process according to the embodiment of the present invention successfully fabricates structures in which relatively low overlaid portions are formed in a contact portion. In other words, this FSW process can produce structures having a high welding strength.

In the example, Al—Mg alloy and Al—Si alloy are used as the materials of the welded members. However, the present invention is not limited to this configuration. Alternatively, any alloys can be used as welded members, unless two members have the same shearing strength.

From the aforementioned explanation, those skilled in the art ascertain the essential characteristics of the present invention and can make the various modifications and variations to the present invention to adapt it to various usages and conditions without departing from the spirit and scope of the claims.

What is claimed is:

1. A friction stir welding process comprising:
positioning a first welded member and a second welded member such that both members overlap each other, thereby defining an overlapped region; and
inserting a rotating pin into the overlapped region from a surface of the second welded member, so that the first and second welded members are joined together,
wherein the first welded member has a lower shearing strength than that of the second welded member.

2. The friction stir welding process according to claim 1,
wherein the first welded member is made of Al—Si alloy, and the second welded member is made of Al—Mg alloy.

3. A friction stir welded structure being formed by a process comprising:
positioning a first welded member and a second welded member such that both members overlap each other, thereby defining an overlapped region; and
inserting a rotating pin into the overlapped region from a surface of the second welded member, so that the first and second welded members are joined together,
wherein the first welded member has a lower shearing strength than that of second welded member.

4. The friction stir welded structure according to claim 3,
wherein the first welded member is made of Al—Si alloy, and the second welded member is made of Al—Mg alloy.
